(19) United States
(12) Patent Application Publication
(10) Pub. No.: US 2008/0009568 A1
(43) Pub. Date: Jan. 10, 2008

(54) Methods to disperse and exfoliate nanoparticles

(76) Inventors: Nitin Kumar, Mountain View, CA (US); Shawna Marie Liff, Somerville, MA (US); Gareth H. McKinley, Acton, MA (US)

Correspondence Address: Valarie B. Rosen;Choate, Hall & Stewart, LLP, Two International Place, Boston, MA, 02110, US

(21) Appl. No.: 11/253,219

(22) Filed: Oct. 18, 2005

Related U.S. Application Data
(60) Provisional application No. 60/619,883, filed on Oct. 18, 2004.
(60) Provisional application No. 60/620,387, filed on Oct. 19, 2004.

(51) Int. Cl. C08K 3/00; C08L 75/00; C08K 3/34

(52) U.S. Cl. 524/80; 524/839; 524/445

(57) ABSTRACT

A method of dispersing particles in a medium. The method includes providing a first particle/solvent dispersion comprising the particles and a first solvent, adding a second solvent to the first particle/solvent dispersion to form a second particle/solvent dispersion, wherein the first solvent and the second solvent are miscible, and extracting substantially all of the first solvent from the second particle/solvent dispersion to form a third particle/solvent dispersion.

This application claims the priority of Provisional Patent Applications Nos. 60/619,883, filed Oct. 18, 2004, and 60/620,387, filed Oct. 19, 2004, the entire contents of both of which are incorporated by reference herein.

### FIELD OF THE INVENTION

This invention relates to the dispersion and exfoliation of nanoparticles.

### BACKGROUND OF THE INVENTION

Nanocomposite materials based on polymers and nanoparticles have many potential applications as high performance materials with enhanced mechanical, thermal electrical, and/or optical properties. Efficient and complete dispersion of nanoparticles in polymer matrices enables production of nanocomposites with superior properties. The potential of nanoparticles to enhance the mechanical properties of nanocomposites is optimized when the nanoparticles are fully dispersed in the polymer. For clay particles, dispersion is a two part process—exfoliation, e.g., separation of stacked clay particles, and dispersion of the separated particles. Incomplete exfoliation and dispersion results in nanocomposites with small or no improvement in the mechanical, thermal, electrical, and/or optical properties.¹⁻⁵ Many nanoparticles are not miscible with engineering polymers. Therefore, these nanoparticles are not directly dispersed in the polymers. Many nanoparticles are dispersible only in aqueous solutions, while many engineering polymers are not soluble in aqueous solutions. Some current methods of dispersing nanoparticles, including clay particles, in polymers are: (1) monomer interaction/exfoliation method, (2) monomer modification method, (3) chemical modification of nanoparticles, (4) common solvent method, (5) melt dispersion method. These methods result in various degrees of dispersion of nanoparticles in polymers.⁶⁻¹⁷ These methods cannot always fully disperse clay particles throughout a polymer matrix and do not always promote desirable properties. For example, chemical modification of nanoparticles may result in thermal degradation. Furthermore, the modifying agent may not be compatible with the matrix polymer and the process itself adds to production costs, as does the process of monomer modification. Some of these methods of are limited usefulness because of, e.g., the limited numbers of solvents that can both dissolve polymers and disperse nanoparticles. As a result, it is desirable (i) to develop a new method to effectively and uniformly disperse nanoparticles in polymers, and (ii) to improve the mechanical, thermal, optical, and/or electrical properties of composites by more complete exfoliation and dispersion of nanoparticles therein.

### SUMMARY OF THE INVENTION

In one aspect, the invention is a method of dispersing particles in a medium. The method includes providing a first particle/solvent dispersion comprising the particles and a first solvent, adding a second solvent to the first particle/solvent dispersion to form a second particle/solvent dispersion, wherein the first solvent and the second solvent are miscible, and extracting substantially all of the first solvent from the second particle/solvent dispersion to form a third particle/solvent dispersion.

Providing may include dispersing the particles in the first solvent. The method may further include dissolving a polymer in the third particle/solvent dispersion. Dissolving a polymer may include dissolving the polymer in a solvent and combining the third particle/solvent dispersion and the polymer solution. The method may further include extracting at least a portion of the solvent from the third particle/solvent dispersion. The method may further include one or more of drying the third particle/solvent dispersion to remove at least a portion of the second solvent, film drying the third particle/solvent dispersion, spray-drying the third particle/solvent dispersion, wet spinning the third particle/solvent dispersion, electrospinning the third particle/solvent dispersion, and precipitating the polymer and particles from the third particle/solvent dispersion.

The polymer may be a block copolymer, for example, a polyurethane, a polyester, polyethylene glycol-polypropylene glycol-polyethylene oxide polymer, acrylonitrile-butadiene-styrene polymer, or a polyurea. The polyurethane may include polytetramethylene oxide.

Extracting may include distillation. The first solvent may be selected from water, methanol, ethanol, n-propanol, 2-propanol, butanol, chloroform, dichloromethane, acetone, glycerol, ethylene glycol, or a mixture of any of the above. The second solvent may be selected from xylene, tetrahydrofuran, dichlorobenzene, dimethylacetamide, dimethylformamide, dimethylsulfoxide, sulfolane, ethylene glycol, water, n-methyl pyrrolidinone, an alcohol having at least six carbons, or a mixture of any of the above.

Providing comprises increasing the ionic strength or modifying the pH of the first solvent. The method may further include including a salt in the first particle/solvent dispersion. The method may further include including a base in the first particle/solvent dispersion. The method may further include including a surfactant in the first particle/solvent dispersion. The method may further include including one or more of polyethylene glycol and polypropylene glycol in the first particle/solvent dispersion.

The concentration of particles in the first particle/solvent dispersion may be at least about 0.01 weight percent, for example, at least about 1 wt %, at least about 3 wt %, at least about 10 wt %, at least about 20 wt %, at least about 30 wt %, at least about 40 wt %, at least about 50 wt %, at least about 60 wt %, at least about 70 wt %, at least about 80 wt %, or at least about 90 wt %.

The particles may be about 1 nm to about 5 μm, for example, about 1 nm to about 1 μm, about 1 μm to about 5 μm. The particles may have at least one aspect ratio between about 1:1 and about 300:1, for example, between about 1:1 and about 10:1, between about 10:1 and about 100:1, or between about 100:1 and about 300:1.

In another aspect, the invention is a particulate reinforced composite produced by the steps of: providing a first particle/solvent dispersion comprising the particles and a first solvent, adding a second solvent to the first particle/solvent dispersion to form a second particle/solvent dispersion, wherein the first solvent and the second solvent are miscible, extracting substantially all of the first solvent from the second particle/solvent dispersion to form a third particle/solvent dispersion, dissolving a polymer in the third particle/solvent dispersion to form a dispersed particle/dissolved polymer mixture, and extracting at least a portion of the solvent from the mixture.

Dissolving a polymer may include dissolving the polymer in a solvent and combining the third particle/solvent dispersion and the polymer solution. Providing may include dispersing the particles in the first solvent.

Providing may include increasing the ionic strength or modifying the pH of the first solvent. The method may further include including a salt in the first particle/solvent dispersion, including a base in the first particle/solvent dispersion, and/or including a surfactant, for example, one or more of polyethylene glycol and polypropylene glycol, in the first particle/solvent dispersion.

All ratios are by weight unless otherwise specified.

### BRIEF DESCRIPTION OF THE DRAWING

The file of this patent contains at least one drawing executed in color. Copies of this patent with color drawings will be provided by the Office upon request and payment of the necessary fee.

The invention is described with reference to the several figures of the drawing, in which,

FIG. 1A is an electron microscope image of 10% Laponite nanoparticles dispersed in Elasthane according to an embodiment of the invention.

FIG. 1B is a AFM tapping mode phase micrograph of 10% Laponite nanoparticles dispersed in Elasthane according to an embodiment of the invention.

FIG. 1C shows the wide angle x-ray diffraction (WAXD) spectra of pure Laponite, and pure, 10 wt %, and 20 wt % Laponite-filled Elasthane produced according to an embodiment of the invention.

FIGS. 1D and E show the results of TGA measurements on Laponite/Elasthane composites of various compositions. The degradation temperature is defined as the point when 5% of the nanocomposite mass is lost.

FIG. 2A is an image of a Laponite/Elasthane film according to an embodiment of the invention through a crossed polarizer showing evidence of crystalline domains (image width=2700 μm). The right side of the sample has been strained in the direction shown by the white arrow.

FIG. 2B is a magnified image of a crystalline domain in an unstrained 10% Laponite/polyurethane film (image width=337 μm).

FIG. 2C is a magnified image of a crystalline domain as seen under crossed polarizers in a 10% Laponite/polyurethane film that has been deformed (image width=270 μm).

FIG. 2D is a graph illustrating the crystalline fraction of 10 wt % Laponite in Elasthane during melting, including micrographs of the composite during heating, as viewed through crossed polarizers.

FIGS. 2E-G are light micrographs, through crossed polarizers, of a thin film of 10 wt % Laponite in Elasthane during annealing at 60° C. (E:18 hr; F:38 hr; G:68 hr).

FIG. 3A is a graph showing tensile measurements of Laponite/Elasthane films according to an embodiment of the invention at various fractions of Laponite;

FIGS. 3B-D are graphs illustrating the B) elastic modulus, C) toughness, and D) strength and extensibility of Laponite/Elasthane films according to an embodiment of the invention at various Laponite fractions.

FIG. 4A shows the variation of storage modulus with temperature of nanocomposite films according to an embodiment of the invention with 0 to 20% Laponite (the heat deflection temperature is defined as the temperature at which E′=8 MPa, see ISO 75 method C).

FIG. 4B shows the storage modulus data of FIG. 4A at various temperatures, plotted against the fraction of Laponite. The line indicates the measurement limits of the apparatus.

FIG. 4C shows the variation in loss modulus with temperature of Laponite nanocomposite films according to an embodiment of the invention (Legend in FIG. 4A).

FIG. 4D shows the variation of Tan Delta with temperature for the samples in FIG. 4C (Legend in FIG. 4A).

FIG. 5A shows the heat flow during the first heating and cooling cycle during differential scanning calorimetry (10° C./min) of Elasthane/Laponite nanocomposites according to an embodiment of the invention, showing both irreversible and reversible phase transitions.

FIG. 5B shows the heat flow during the second heating and cooling cycle during differential scanning calorimetry (10° C./min) of the sample of FIG. 5A, showing only reversible phase transitions.

FIG. 6A is a series of photographs taken as a pure Elasthane (left) and 20% Laponite-Elasthane composite according to an embodiment of the invention were heated under tensile stress (scale bar=46 mm).

FIG. 6B depicts the tensile compliance of the samples of FIG. 6A as the temperature was ramped from 53° C. to 90° C. at about 0.02° C. s⁻¹.

FIG. 7A-B are electron micrographs of 10% Laponite nanoparticles dispersed in HDI/PEO/PPO polyurethane (A) and HDI/PTMO polyurethane (B) according to an embodiment of the invention

FIG. 7C shows the WAXD spectra of pure Laponite and pure and 10 wt % Laponite-filled HDI/PEO/PPO polyurethane and HDI/PTMO polyurethane according to an embodiment of the invention.

FIG. 8 is a graph showing stress-strain curves in uniaxial tension of HDI/PTMO polyurethane films with and without 10 wt % Laponite according to an embodiment of the invention.

### DETAILED DESCRIPTION OF CERTAIN PREFERRED EMBODIMENTS

We have developed a new approach to disperse nanoparticles in solvents in which they are not normally soluble. These dispersions may be used in many applications, for example, the preparation of nanocomposites with commercially available polymers as well as specially synthesized polymers. These methods may be used to achieve high exfoliation of clay particles and to more completely disperse a variety of nanoparticles in polymers. In some embodiments, these method enhance, the mechanical properties and increase the heat distortion temperature of the resulting composite.

In one embodiment, particles (NP) are dispersed in a first solvent (Solvent A) to form a first particle/solvent dispersion (NP-A). A second solvent (Solvent B) is added to form a second dispersion, NP-A-B. Solvent A is then extracted from NP-A-B to form a third particle/solvent dispersion, NP-B.

A variety of particles are suitable for use with the invention. The invention is particularly suited for particles that are used as a reinforcement phase in polymer composites. Exemplary materials include smectite clays, silica nanoparticles, carbon black, carbon nanoparticles, titania nanoparticles, and alumina nanoparticles, and carbon nanotubes. Exemplary smectite clays include montmorillonite, hectorite, and LAPONITE™. Laponite is a synthetic clay having the formula Na⁺_{0.7}[(Si₈Mg_{5.5}Li_{0.3})O₂₀(OH)₄]^{-0.7}, available from Rockwood Specialties (Princeton, N.J.) and Southern Clay Products (Gonzales, Tex.). Exemplary materials are available from Southern Clay Products, microParticles GmbH, Interfacial Dynamics Corporation, and Sigma-Aldrich. Semiconductor particles and quantum dots may also be used in embodiments of the invention. Exemplary particle compositions include but are not limited to CdS, CdTe, CdSe, InGaP, GaN, PbSe, PbS, InN, InP, and ZnS. Semiconductor nanoparticles are available from Invitrogen Corporation and Evident Technologies. One skilled in the art will be aware of other sources for appropriate particles.

The particles may range in size from about 1 nm or less to about 5 μm or greater. The nanoparticles may be regularly shaped, for example, approximately spherical or polyhedral or with an aspect ratio of about 1:1. Alternatively, the nanoparticles may be acicular, for example, disc shaped or rod shaped, with at least one aspect ratio greater than 1:1, for example, 2:1, 5:1, or 10:1, 25:1, 100:1, or 300:1.

In one embodiment, Solvent A may include aqueous or polar solvents or solvent mixtures. An especially suitable solvent for use as Solvent A is water, but alcohols and other polar solvents in which the particles are dispersible may be used as well. Exemplary solvents for use as Solvent A include but are not limited to water, methanol, ethanol, n-propanol, 2-propanol, butanol, chloroform, dichloromethane, acetone, glycerol, and ethylene glycol. Salts, surfactants, and/or other materials may be added to the solvent to increase the solubility of the particles or optimize some other property of the dispersion. For example, various salts, including sodium chloride, sodium citrate, tetrasodium pyrophosphate, may be added to the dispersion to change its ionic strength. Alternatively or in addition, acids or bases, e.g., potassium hydroxide, sodium hydroxide, sulfuric acid, or hydrochloric acid, may be added to the dispersion to change its pH. Low molecular weight polyethylene glycol or polypropylene glycol may also be added. Ionic or non-ionic surfactants may also be employed. Exemplary surfactants include quaternary ammonium salts, e.g., CTAB (cetyltrimethylammonium bromide), SDS (sodium dodecyl sulfate), Triton X-100, sodium deoxycholate, N-lauroylsarcosine sodium salt, and lauryldimethylamine-oxide. One skilled in the art will recognize that the choice of surfactant will not only depend on the material being dispersed but on the pH of the solution, since some particles, e.g., silica, take on different charges at different pH. Alternatively or in addition, a coating layer on nanoparticles, e.g., quantum dots, may be optimized for a particular solvent/surfactant system. For example, thiol capped quantum dots are well known to those skilled in the art (see U.S. Pat. No. 6,426,513, the contents of which are incorporated by reference), and amine and carboxyl-capped quantum dots are available commercially, for example, from Invitrogen.

In one embodiment, clays are added to Solvent A at about 0.01 to about or 4 weight percent. Different particles may be added at different concentrations to form the NP-A dispersion. For example, differently shaped nanoparticles may be added at different concentrations, for example, at least about 10%, 20%, 30%, 40%, 50%, 60%, 70%, 80, 90%, or more. The theoretical maximum volume fraction for random packing of spherical particles is 64% by volume, and this may provide an upper limit for some particles. Higher concentrations may be achieved with mixtures of larger and smaller particles. More irregularly shaped particles may be difficult to disperse at higher concentrations, depending on the aspect ratio. The upper limit of concentration is determined in part by the critical packing fraction, or percolation limit, the concentration at which the distance between particles is less than one particle diameter for a randomly arranged population; Of course, the packing fraction may be higher for more ordered arrangements of particles, as described in Weitz, Science, (2004) 303:968-969. The ability of the nanoparticles to disperse and remain in a stable and unaggregated state is a result of the surface charge, surface chemistry, and wettability of the nanoparticles, and the ion salvation, dipole moment and dielectric constant of Solvent A. The nanoparticles need not be chemically modified before dispersion in Solvent A but may be so modified using techniques known to those skilled in the art.

A second solvent or solvent mixture (B) may then be added to the NP-A, so that the nanoparticles remain in the unaggregated state. The second solvent may have a higher boiling point than Solvent A and be miscible with Solvent A. In addition, where a nanocomposite is being formed from the dispersion, Solvent B may be a solvent for the material employed as the matrix phase. Exemplary solvents for use as Solvent B include but are not limited to xylene, dichlorobenzene, n-methyl pyrrolidinone (NMP), dimethylacetamide (DMAC), dimethylformamide (DMF), dimethylsulfoxide (DMSO), sulfolane, ethylene glycol, and higher molecular weight alcohols, e.g., alcohols having at least six carbons, for example, hexanols, phenol, and dodecanols. Water may also be used where appropriate. Solvent B may be a mixture of solvents as well. This dispersion is called NP-A-B. In some embodiments, it may be desirable to agitate or heat the dispersion as Solvent B is being added. Solvent B may be added to Solvent A in practically any ratio, for example, between 100:1 and 1:100.

Even where the nanoparticles are not directly dispersible in B due to their limited wettability, limited ion salvation, or surface chemistry, the nanoparticles may remain in the dispersed state when Solvent B is added to NP-A because addition of Solvent B to NP-A may not significantly disturb inter-particle or particle solvent interactions.

Solvent A can be extracted from NP-A-B to obtain fully dispersed nanoparticles in Solvent B (NP-B). In one embodiment, NP-A-B is distilled to remove Solvent A. The distillation temperature and vacuum are chosen based on the boiling points of the two solvents. Where the two solvents exhibit an azeotrope at certain concentrations, the azeotrope may be easily broken by the addition of a third solvent. In this way, we can exchange the solvent and obtain completely dispersed nanoparticles in Solvent B. Trace amounts of Solvent A may be left in NP-B without jeopardizing the final product. Therefore this method is called a Solvent Exchange Process. The dispersion NP-B can be used for many applications.

One use for the NP-B dispersion is fabrication of polymer nanocomposites with superior properties using exfoliated and dispersed nanoparticles. In this embodiment, Solvent B should be chosen so that polymer (P) is soluble in B. The polymer need not be soluble in Solvent A. The polymer is dissolved in NP-B to obtain a solution of polymer and fully dispersed nanoparticles in solvent B. This solution is called P-NP-B and may be heated, cooled, or agitated, for example, by sonication, to fully dissolve P. In one embodiment, the polymer is dissolved in the solution at about 2 weight percent or less. Higher concentrations may be achieved using techniques known to those skilled in the art, e.g., agitation or heating.

Exemplary polymers for use in nanocomposites include polyurethanes such as ELASTHANE™, available from Polymer Technology Group, Berkeley, Calif. Elasthane is formed by reaction of polytetramethylene oxide (PTMO) with an aromatic isocyanate, 4,4′-methylene bisphenyl diisocyanate (MDI). 1,4-butanediol may be used as a chain extender. Other exemplary polymers include other PTMO polyurethanes, Estane™, available from Noveon, Esthane™, available from BF Goodrich, Lycra™, available from Invista, shape memory polymers, polyester block co-polymers, Pluronics polymers (e.g., polyethylene glycol-polypropylene glycol-polyethylene oxide block co-polymers), and polyurea block co-polymers. However, it is not necessary that the polymer be a block co-polymer so long as it is soluble in Solvent B; of course, Solvent B may be optimized for a particular polymer. For example, DMF is a solute for a wide variety of polymers, including polyacrylates, polymethacrylates, poly methyl methacrylates, polyacrylonitrile, polyimides, carboxymethyl cellulose, polyethylene oxide, polyethers, polyethyl acrylates, glycerine polyesters, acrylonitrile/butadiene/styrene (ABS) rubbers, and polyamides. Polycarbonates and polyolefins such as polyethylene and polypropylene also exhibit solubility in dichlorobenzene; some polyolefins are also soluble in toluene, as are polyisoprene, polybutylene, epoxy resins, and polyesters. DMSO is a good solvent for many polymers, including but not limited to polyacrylamides, polyacrylic acids, quaternary amine modified cellulose, dextrans, gelatins, and octadecylmethacrylate. While THF has a lower boiling point than many common solvents, it is a good solvent for polymers such as polystyrene, polyvinylchloride, polycarbonates, polymethacrylates, and some isoprene-based rubbers. DMAC is a good solvent for polyacetals, Delrin™, polyurethanes, polyureas, and polyoxymethylene. In some embodiments, mixtures of THF with higher boiling point solvents may be employed. Where THF is used as a component of Solvent B, it may also be desirable to combine the THF with the polymer before addition of an NP-B, where solvent B′ is one component of Solvent B. In this embodiment, the nanoparticles are suspended in one component of Solvent B while the polymer is dissolved in the other component of Solvent B. One skilled in the art will be aware of other solvent/polymer pairs that can be exploited for use with the invention.

A nanocomposite may be obtained from P-NP-B by any method known to those skilled in the art, including but not limited to drying to remove solvent B, including film drying, spray drying, wet spinning, and electrospinning, and precipitation. Films and non-woven mats of practically any thickness may be produced using techniques well known to those skilled in the art. Techniques known to those skilled in the art may be used to adapt fiber drying methods to produce fibers of any gauge. These fibers may be braided, coiled, woven, or otherwise gathered using any technique known to those skilled in the art. Bulk polymers may be produced as well. For bulk composites, it may be desired to use techniques where solvent is evaporated at higher temperatures or to otherwise manipulate the process so that polymer may be dissolved in the solvent at a higher concentration to reduce the amount of solvent required. Solvent remaining in the composite after processing may set as a plasticizer.

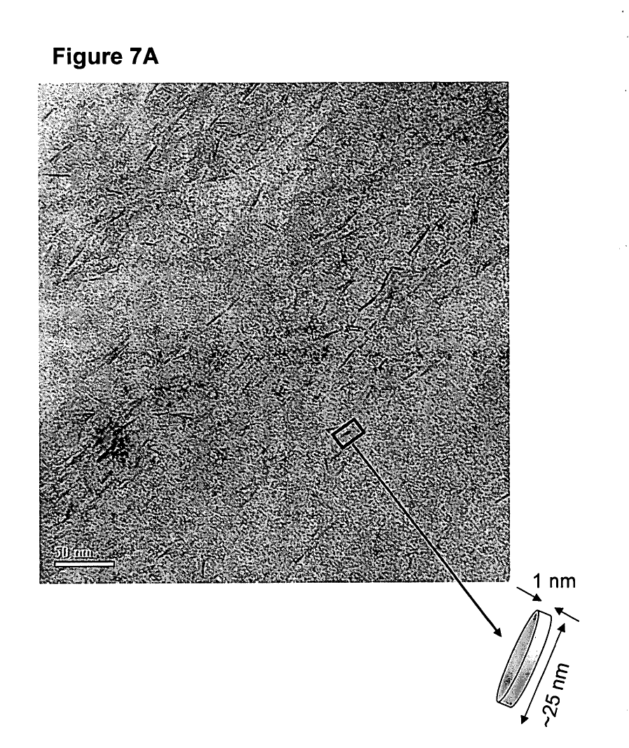

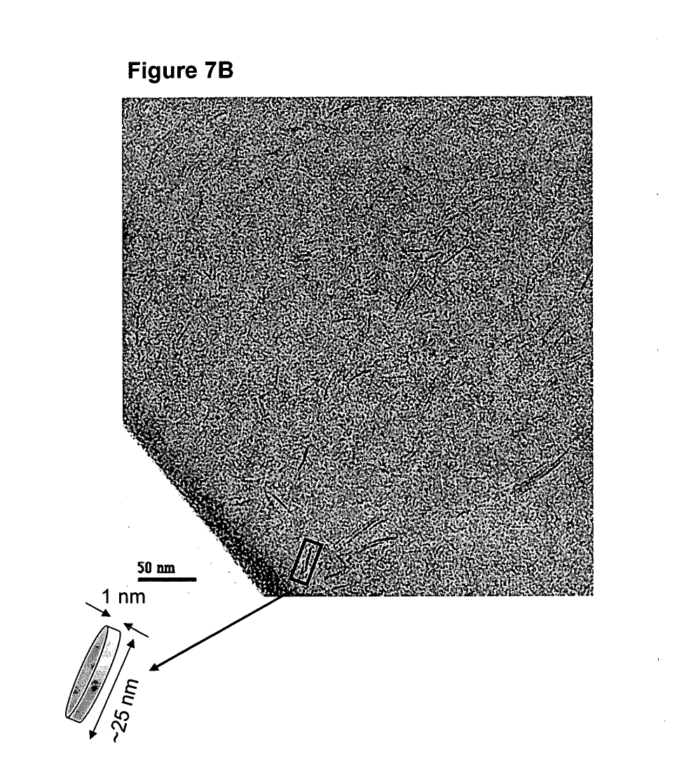

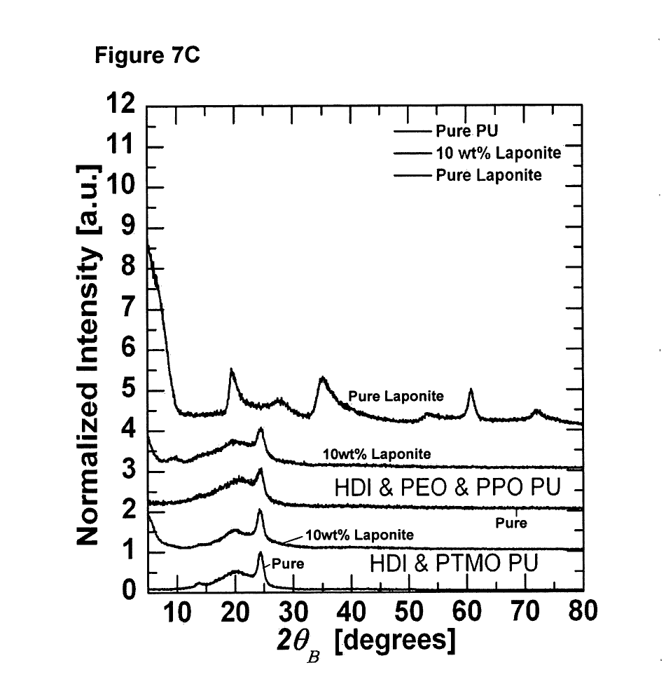

Even where nanoparticles are fully dispersed in NP-B, they may order themselves in NP-P because of particle-polymer interactions. For example, FIG. 7A shows a banded microstructure; the Laponite particles have a stronger affinity for the PEO/PPO blocks of the HDI/PEO/PPO polymer than for the HDI blocks. The composite of FIG. 7B exhibits slight aggregation of the nanoparticles; the Laponite particles have a negative charge, which is attracted to the partial positive charge of the HDI blocks of the HDI/PTMO polyurethane and may cause the particles to aggregate. Dispersion of irregularly shaped particles has two components, the distribution of the particles within the polymer and their orientation. In some embodiments, it may be desirable for the particles to be ordered within the polymer with respect to orientation (e.g., an ordered dispersion). This allows a higher fraction of particles in the particle/polymer composite. For example, the samples in FIG. 7 both have 10 wt % Laponite, well in excess of the critical packing fraction (5.9 wt %, or 2.5% by volume). The complete exfoliation and dispersion of the nanoparticles in NP-B facilitates greater control over the eventual microstructure of the composite by allowing the microstructure to be determined by polymer/nanoparticle interactions rather than forcing the polymer to disperse an aggregate of nanoparticles.

The techniques of the invention may be easily implemented at the production level. For example, the polymer may be synthesized in the NP-B dispersion. Techniques for synthesizing such composites are disclosed in U.S. Pat. No. 6,900,262, U.S. Patent Publication No. 20050065248, and U.S. Patent Publication No. 20040259999 the contents of all of which are incorporated herein by reference. Alternatively, NP-A may be added to a solution containing just-synthesized polymer, in which the same solvent that was used to synthesize the polymer serves as Solvent B. Heat or agitation may be employed to facilitate mixing. In an alternative embodiment, the process may be applied during fiber processing or film coating. The equipment to perform the solvent exchange is common and is often already available in a polymer or composite production line, reducing capital costs to implement these techniques, which employ solvents that are already in common use in industrial polymer and composite production.

Nanocomposites produced using the techniques of the invention may be exploited in a variety of applications. For example, these composites may be used to form reinforcing or abrasion resistant coatings. The composite may be applied to a substrate using any technique known to those skilled in the art. Clear composites may be used to coat glass and plastic windows, face masks, and other objects designed to be transparent or translucent. These coatings are often used to prevent scratches; use of composites according to an embodiment of the invention enables the coatings to be used at higher temperatures. These materials may also serve as gas barrier coatings for clothing. They may also be used for packaging, depending on the amount of gas permeability desired. They may also be used in stents and other biomedical devices requiring stiffness and a large strain to failure. Of course, these nanocomposites may also be used to form fibers, films, and coatings for any application where nanocomposites are useful.

In addition to enhancing the thermal and mechanical properties of polymers, nanoparticles such as quantum dots can also introduce interesting optical and electronic properties to polymer matrix composites. For example, prior art nanocomposites using II-VI quantum dots have been used in a variety of optoelectronic and photovoltaic applications. Composites according to an embodiment of the invention can find uses in LEDs, filters, solar cells, and photodetectors. They may also be employed in telecommunications, for example, in sources, modulators, channel monitoring devices, and switches for optical signals. In other embodiments, nanoparticles in composites according to the invention may be used as pigments or to modify the dielectric constant of the polymer matrix. Quantum dots can also introduce photoconductive properties to conductive polymers. Composites according to the teachings of the invention may be fabricated in any conformation, e.g., fibers, films, or beads.

### EXAMPLES

### Example 1

One gram of Laponite™ was added to 100 g water and stirred for one day. 200 g of dimethylacetamide (DMAC) was added to the Laponite/water suspension and stirred for one day. The water was removed from the mixture by vacuum distillation from 25 to 165° C. and above with absolute pressures ranging from 10 millibar to 1000 millibar to form a Laponite/dimethylacetamide suspension. 2 g of Elasthane™ were dissolved in the suspension. At this stage, solution concentrations may be further adjusted by removing the DMAC via distillation or by adding more DMAC. Films of an Elasthane/Laponite nanocomposite were prepared by evaporation of the solvent. The resulting films contained between 0 and 20% Laponite.

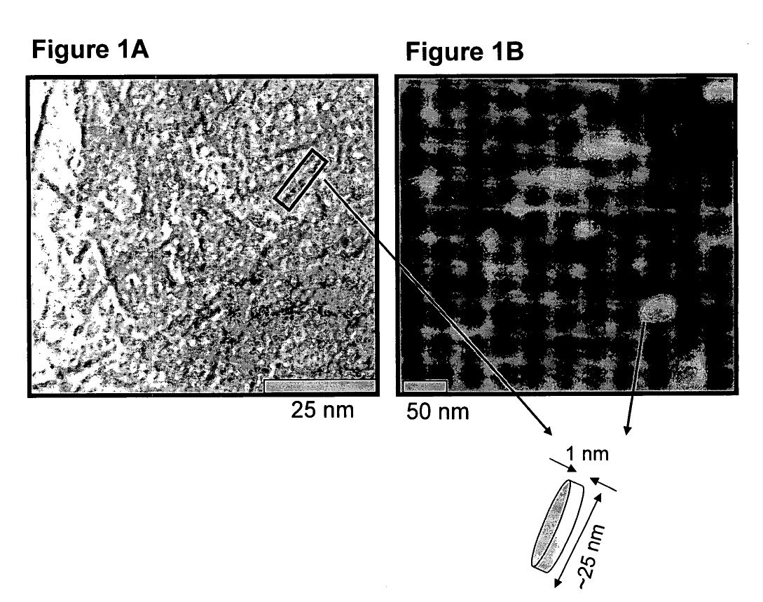

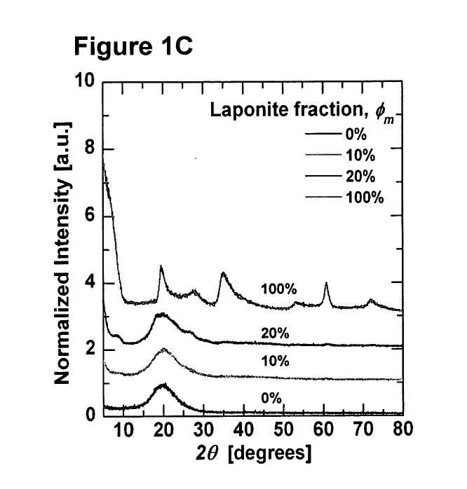

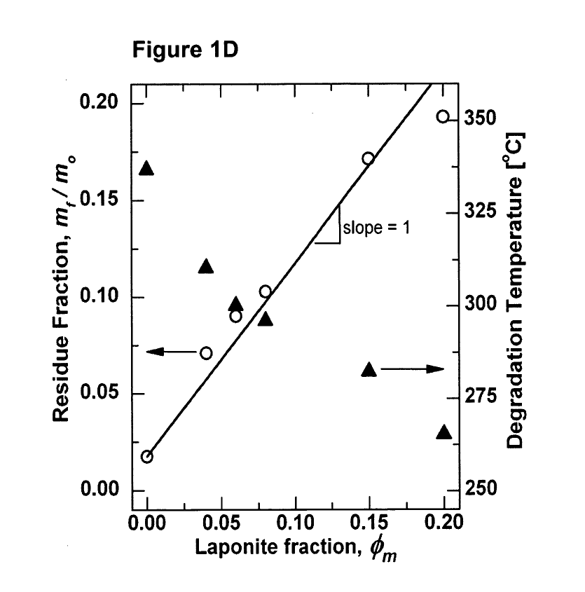

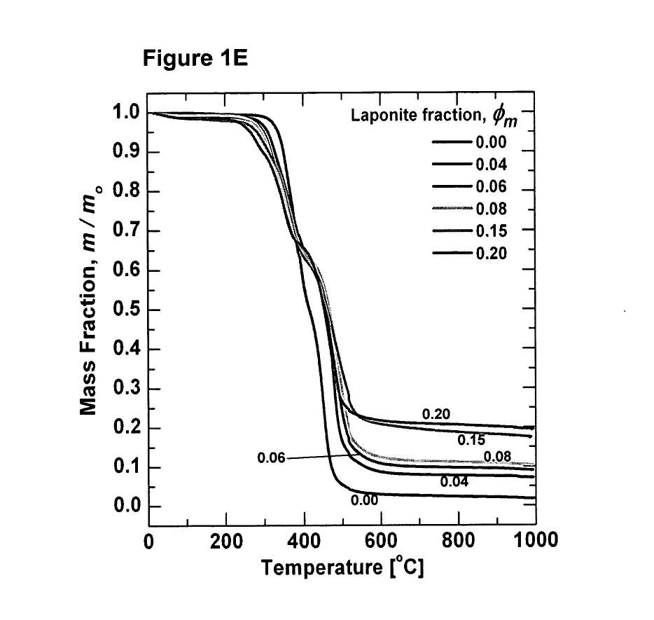

The complete dispersion and exfoliation of Laponite nanoparticles within the composite is demonstrated using transmission electron microscopy, as shown in FIG. 1A. Laponite nanoparticles are oriented in uncorrelated directions, exhibiting complete dispersion. The thickness of Laponite nanoparticles in FIG. 1A is approximately 1 nm, which is the same as the reported thickness of a single Laponite nanoparticle¹⁸. FIG. 1B is an AFM tapping mode phase micrograph of a composite having the same composition. The bright circular and ellipsoid regions are the nanoparticle faces. This indicates the complete exfoliation of Laponite nanoparticles in Elasthane. Furthermore, the diffraction peaks typical of Laponite are not apparent in the wide angle x-ray diffraction (WAXD) spectra of the nanocomposite, (FIG. 1C) providing further evidence of Laponite exfoliation. Thermal gravimetry was used to verify that the solution cast films indeed contained the specified nanoparticle weight fraction (FIGS. 1D and 1E).

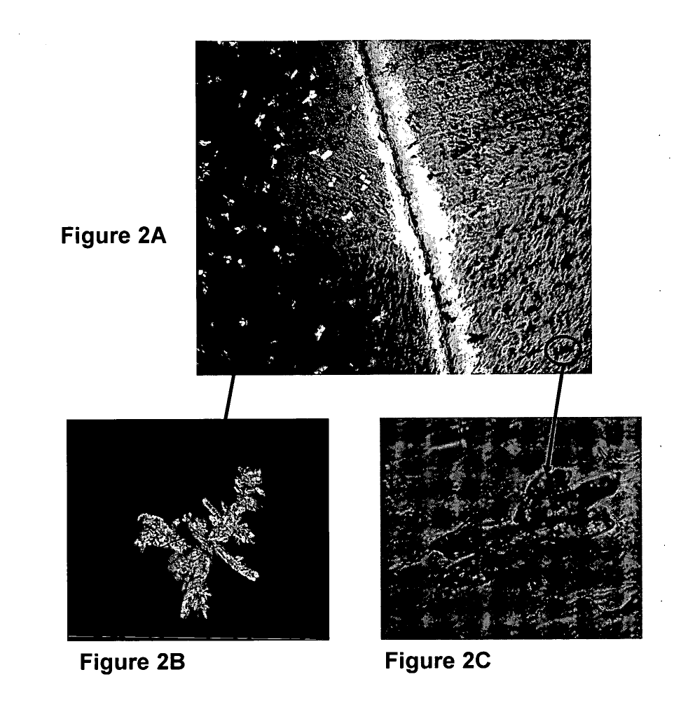

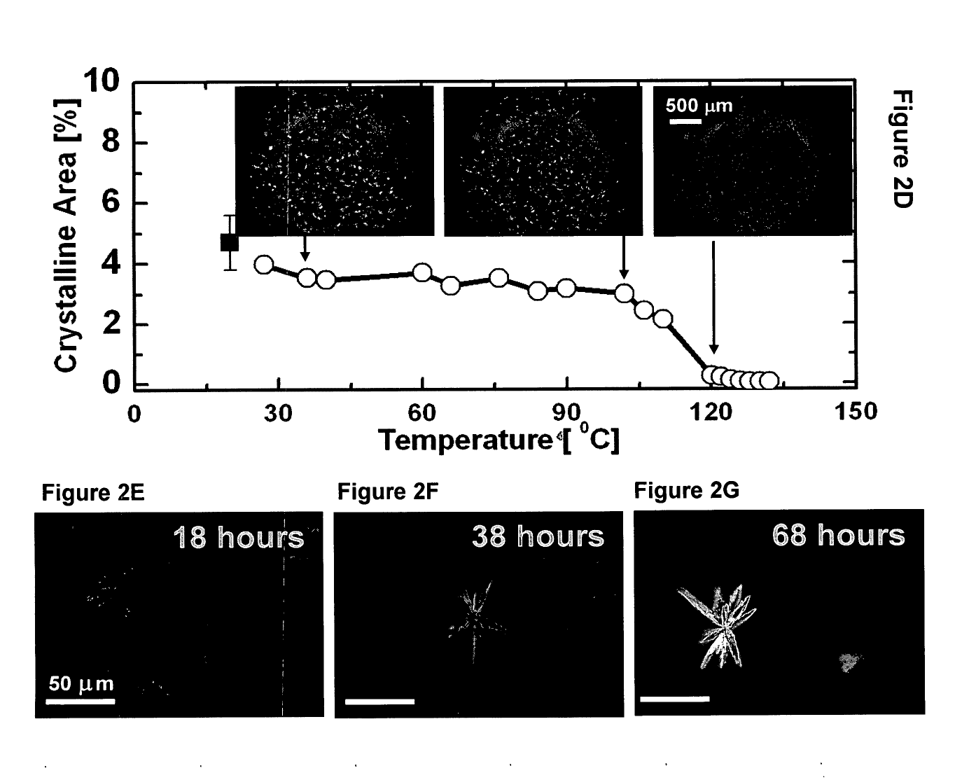

FIG. 2A shows a light micrograph of a thin film containing 10 wt % Laponite after deformation of the film. The dark region to the left shows the amorphous polymer is filled with crystalline domains, but stretching the composite amorphizes the domains, as indicated by the multi-colored deformed portion of the composite, in the right-hand portion of the image. These crystalline domains, as shown in FIG. 2B-C, were apparent in both the pure and Laponite-filled Elasthane. The crystalline regions in both pure and Laponite-filled Elasthane undergo melting at 120° C. (see FIG. 2E), however only the nanocomposites exhibit recrystallization upon annealing, as shown in FIGS. 2D-G. FIGS. 2F-G show the melting and recrystallization of crystallites in an Elasthane thin film containing 10 wt % Laponite annealed at 60° C.

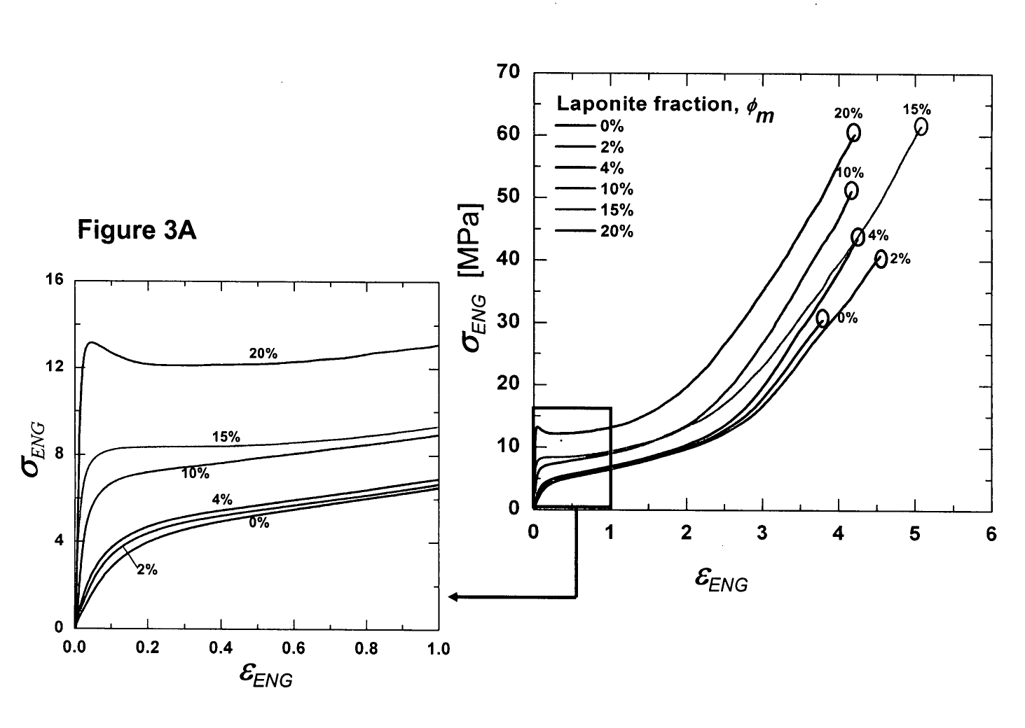

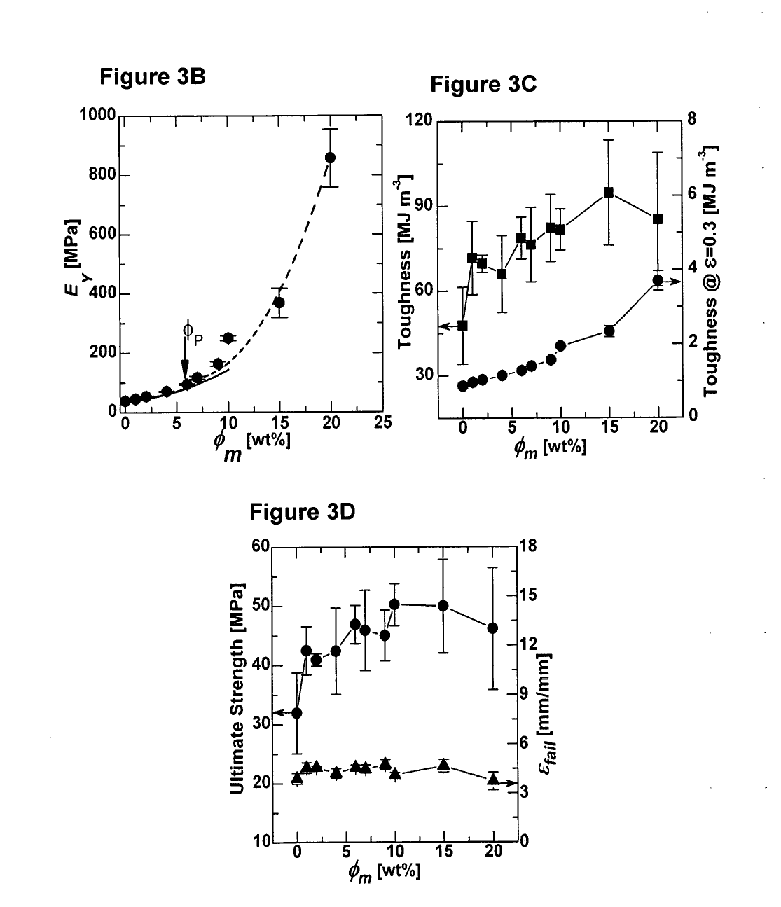

FIG. 3A shows tensile measurements of nanocomposite films containing 0 to 20 wt % Laponite. FIGS. 3B-D show the values of Young's modulus, toughness at 30% strain, toughness at failure, failure strain, and ultimate strength as a function of the fraction of Laponite. The Young's modulus increases monotonically with the fraction of Laponite. At 20 wt %, the Young's modulus is approximately 23 times the value of the pure polymer. The toughness at 30% engineering strain and at failure both increase with Laponite weight fraction. The ultimate strength plateaus at approximately 10 wt % Laponite and exhibits a 50% increase with respect to the pure polymer. The failure strain or extensibility of the polyurethane remains constant with increasing Laponite weight fraction. These results demonstrate that our method of making nanocomposites by the solvent exchange approach is highly effective, and we have been able to achieve a 23-fold increase in the Young's modulus without compromising other mechanical properties, including extensibility, fracture toughness, and strength.

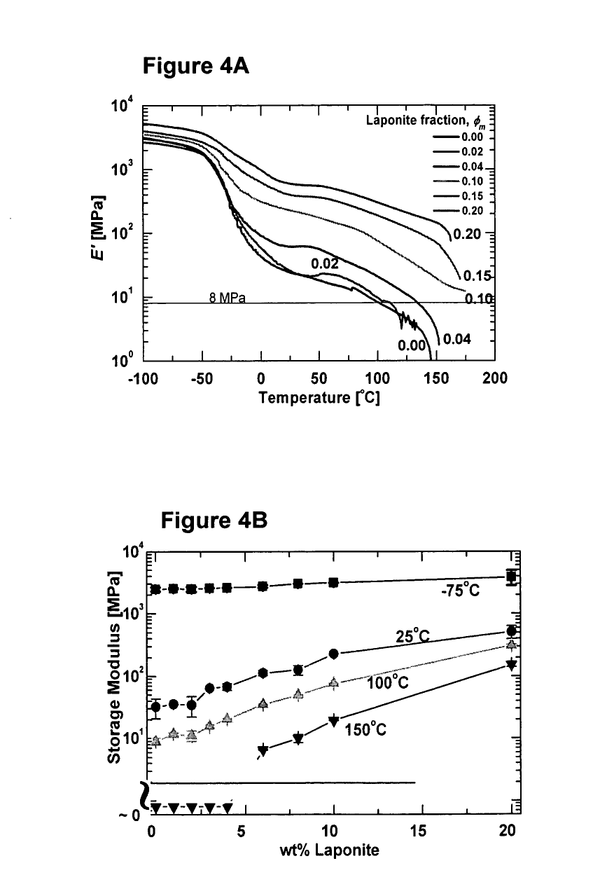

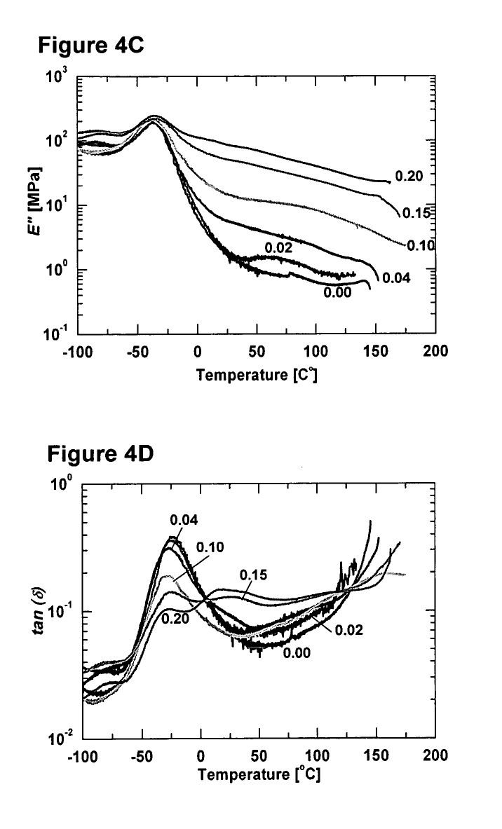

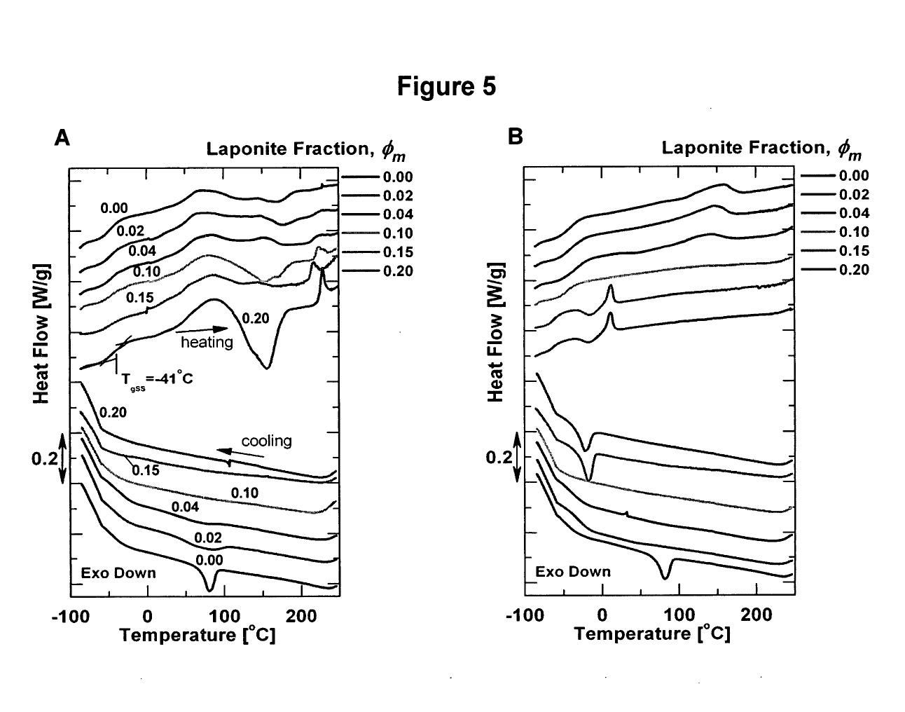

FIG. 4A shows storage modulus measurements of nanocomposite films with 0 to 20% Laponite using a Dynamic Mechanical Analyzer operated at 1 Hz with a 3° C./min ramp. FIG. 4B shows the storage modulus data of FIG. 4A at various temperatures, plotted against the fraction of Laponite. The increase in the value of storage modulus at higher temperature with increasing Laponite fraction shows that the fully exfoliated and dispersed Laponite nanoparticles increase the heat distortion temperature (HDT), the temperature at which the material deforms under load. FIG. 4C shows the loss modulus measurements of Laponite nanocomposite films, while FIG. 4D shows the value of Tan Delta (loss modulus/storage modulus) for the samples. The soft segment glass transition temperature (T_{g}) is invariant; however, a second peak appears above the T_{g} at concentrations greater than 10 wt % Laponite. This peak indicates that the polyurethane becomes more crystalline in nature as the concentration of Laponite increases. Differential scanning calorimetry (10° C./min) during the first heating and cooling cycle reveals both reversible and irreversible phase transitions, as shown in FIG. 5A. Subsequent heating/cooling cycles show reversible transitions, as shown in FIG. 5B. FIGS. 5A and B again show that the soft segment T_{g} remains constant and that there is evidence of the Laponite-induced crystalline phase at concentrations above 10 wt % when a melting endotherm and crystallization exotherm appear in FIG. 5B. Meanwhile, FIG. 5B shows that the pure polyurethane hard segment melting endotherm at ˜165° C. disappears with loading, further indicating that the dispersed nanoparticles help strengthen the material and reduce its susceptibility to high temperature deformation.

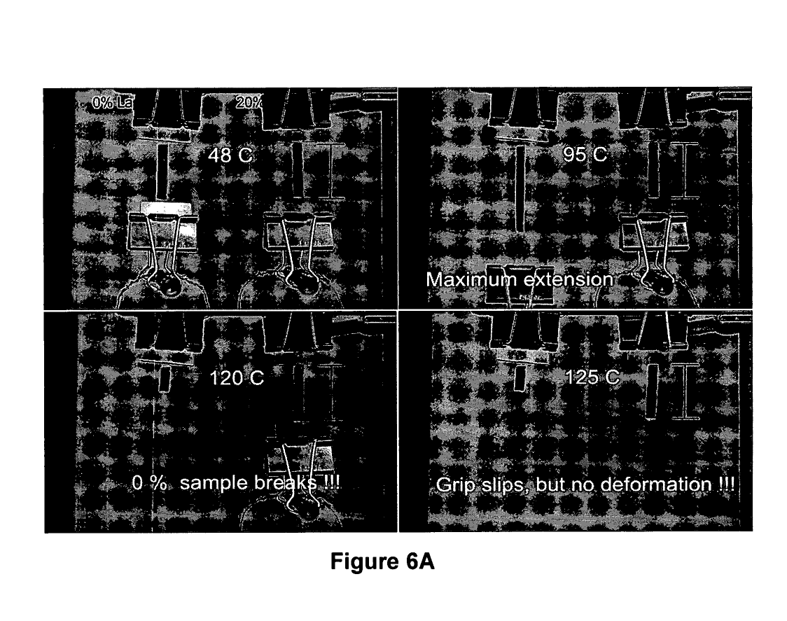

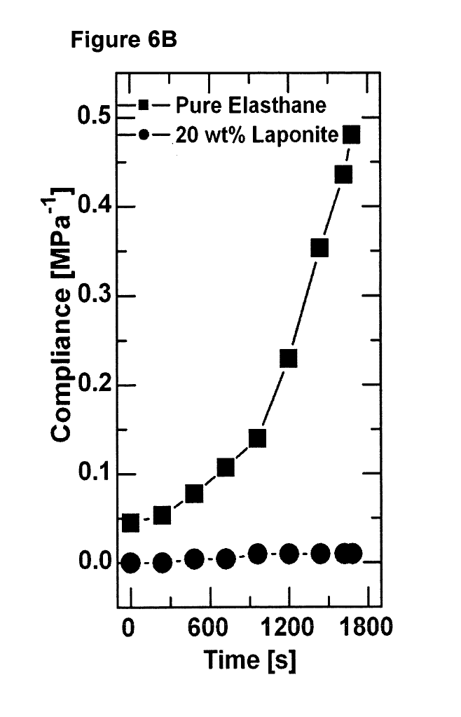

Pure and 20 wt % Laponite-filled Elasthane thin films with the same cross-sectional area were subjected to an initial stress of 1.75 MPa and placed in oven in which the temperature was ramped from 40° C. to 120° C. FIG. 6A shows that the pure Elasthane is highly deformable, while the 20 wt % Laponite-filled film is mechanically stable and withstands the stress without deformation. The pure Elasthane sample exhibited large deformation, reaching the maximum extensional limit at 95° C. and breaking at 120° C. The 20% sample did not show any deformation through 125° C., when the grips slipped from the sample. FIG. 6B is a plot of the tensile compliance of the two thin films as the temperature increases from 53° C. to 90° C. at approximately 0.02° C. s⁻¹. From this plot it is clear that pure Elasthane loses its structural integrity upon heating, but the addition of 20 wt % Laponite to Elasthane significantly expands the useful-operating temperature range of the material.

### Example 2

The same procedure explained in Example 1 was employed to disperse 10 wt % Laponite in two thermoplastic polyurethanes synthesized using commercially available isocyanates, polyols, and chain extenders. The first polyurethane, HDI/PEO/PPO polyurethane, contained 1,6-hexamethylene diisocyanate-1,4-butanediol (HDI-BDO) hard segments (33 wt %) and poly(ethylene oxide)-poly(propylene oxide)-poly(ethylene oxide) (PEO-PPO-PEO) soft segments (1900 g/mol). The other polyurethane, HDI/PTMO polyurethane, contained 1,6-hexamethylene diisocyanate-1,4-butanediol (HDI-BDO) hard segments (37 wt %) and poly(tetramethylene oxide) soft segments (2000 g/mol). These polymers may be produced using the methods in Pollock, G. S., “Synthesis and Characterization of Mechanically Enhanced, Nanostructured Thermoplastic Polyurethane Elastomers,” PhD Thesis, Department of Chemical Engineering, MIT, June 2005 and James-Korley, L. T., “PEO-containing Copolymers as Polyurethane Soft Segments in the Development of High Performance Materials,” PhD Thesis, Department of Chemical Engineering, MIT, May 2005, the contents of both of which are incorporated herein by reference.

The complete dispersion and exfoliation of Laponite nanoparticles within the composite is demonstrated using transmission electron microscopy, as shown in FIGS. 7A-B. The random orientation of the Laponite nanoparticles, which appear as solid dark lines, indicates good exfoliation. FIG. 7C shows the WAXD spectra of pure Laponite, pure HDI & PTMO PU, pure HDI & PEO & PPO PU, and their respective nanocomposites. The diffraction peaks typical of Laponite are not apparent in the nanocomposite spectra, providing further evidence of nanoparticle exfoliation.

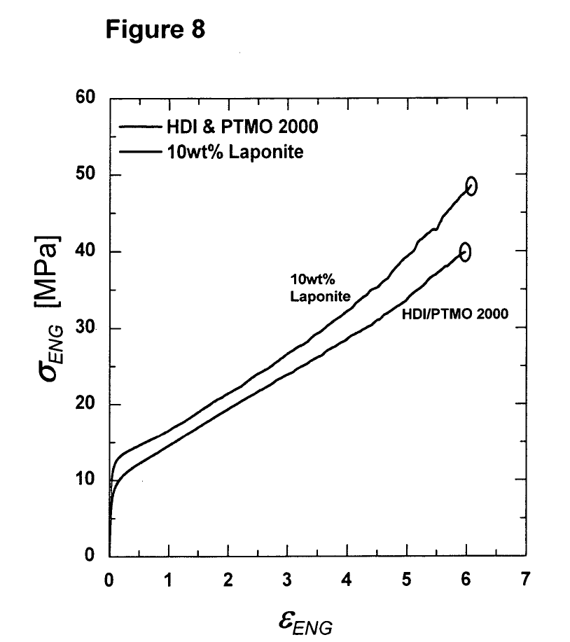

FIG. 8 shows tensile measurements of the pure HDI-PTMO PU (black) and it corresponding nanocomposite containing 10 wt % Laponite (red). The inclusion of Laponite in the HDI & PTMO PU increases the Young's modulus, toughness, and ultimate strength of the material without reducing the material extensibility, as shown in Table 1, below.

TABLE 1
Mechanical Characteristics of Pure HDI/PTMO polyurethane
and its Composite with 10 wt % Laponite

| | Pure HDI/ | With 10 wt |
|---|---|---|
| | PTMO PU | % Laponite |
| Elastic Modulus (MPa) | 260 +/− 18 | 474 +/− 26 |
| Toughness at e = 0.3 (MJ/m³) | 2.57 +/− 0.23 | 3.51 +/− 0.12 |
| Failure Strain (mm/mm) | 6.28 +/− 0.35 | 6.17 +/− 0.26 |
| Ultimate Strength (MPa) | 40 +/− 5 | 48 +/− 2 |
| Total Toughness (MJ/m³) | 149 +/− 21 | 170 +/− 13 |

### Example 3

A PTMO/HDI polyurethane is synthesized by endcapping PTMO with HDI in DMAC under nitrogen with a stannous octoate catalyst. The solution is held at 60° C. for 3 hours. The temperature is then raised to 80-90° C. and the endcapped PTMO polymerized through the stoichiometric addition of HDI and 1,4-butanediol for 12-18 hours.¹⁹

One gram of Laponite™ is added to 100 g water and stirred for one day. 100 g of dimethylacetamide is added to the Laponite/water suspension and stirred for one day. The water is removed from the mixture by vacuum distillation from 25 to 165° C. and above with absolute pressures ranging from 10 millibar to 1000 millibar to form a Laponite/dimethylacetamide suspension. This suspension is then gradually added to the polymer/DMAC solution, with stirring. The polyurethane/Laponite composite is recovered from the solution by precipitation with methanol or by evaporating the solvent.

### Example 4

One gram of Laponite™ is added to 100 g water and stirred for one day. 100 g of dimethylacetamide is added to the Laponite/water suspension and stirred for one day. The water is removed from the mixture by vacuum distillation from 25 to 165° C. and above with absolute pressures ranging from 10 millibar to 1000 millibar to form a Laponite/dimethylacetamide suspension.

One gram of PTMO is added to 100 g DMAC and stirred until completely dissolved. The Laponite/DMAC suspension is gradually added to the PTMO/DMAC solution, with stirring. The PTMO is then endcapped with a stoichiometric amount of HDI under nitrogen with a stannous octoate catalyst. The prepolymer/Laponite/DMAC suspension is held at 60° C. for three hours. The temperature is then raised to 80-90° C. and the endcapped PTMO polymerized through the stoichiometric addition of HDI and 1,4-butanediol for 12-18 hours. A polyurethane/Laponite composite is recovered from the solution by precipitation with methanol or by evaporating the DMAC.

### REFERENCES

1. Chen, A. M. et al. Synthesis and characterization of polyurethane/montmorillonite nanocomposites. Acta Polymerica Sinica, 591-594 (2003).
2. Moon, S. Y., Kim, J. K., Nah, C. & Lee, Y. S. Polyurethane/montmorillonite nanocomposites prepared from crystalline polyols, using 1,4-butanediol and organoclay hybrid as chain extenders. European Polymer Journal 40, 1615-1621 (2004).
3. Song, M., Hourston, D. J., Yao, K. J., Tay, J. K. H. & Ansarifar, M. A. High performance nanocomposites of polyurethane elastomer and organically modified layered silicate. Journal of Applied Polymer Science 90, 3239-3243 (2003).
4. Yu, Z. Z., Yan, C., Yang, M. S. & Mai, Y. W. Mechanical and dynamic mechanical properties of nylon 66/montmorillonite nanocomposites fabricated by melt compounding. Polymer International 53, 1093-1098 (2004).
5. Zhang, X. M., Xu, R. J., Wu, Z. G. & Zhou, C. X. The synthesis and characterization of polyurethane/clay nanocomposites. Polymer International 52, 790-794 (2003).
6. Ajbani, M., Geiser, J. F. & Parker, D. K. Process for preparing nanocomposite, composition and article thereof, U.S. Pat. No. 6,759,464, (2004)
7. Barbee, R. B., Walker, G. J., Matayabas, J. J. C., Lan, T. & Vasiliki, P. Polymer/clay nanocomposite comprising a clay mixture and a process for making same, U.S. Pat. No. 6,653,388, (2003)
8. Grutke, S. & Mehler, C. Thermoplastic nanocomposites, U.S. Pat. No. 6,673,860, (2004)
9. Hwang, W. G., Wei, K. H. & Wu, C. M. Preparation and mechanical properties of nitrile butadiene rubber/silicate nanocomposites. Polymer 45, 5729-5734 (2004).
10. Kanekiyo, H., Miyoshi, T. & Hirosawa, S. Nanocomposite magnet and method for producing same, U.S. Pat. No. 6,790,296, (2004)
11. Kato, M., Matsushita, M. & Fukumori, K. Development of a new production method for a polypropylene-clay nanocomposite. Polymer Engineering and Science 44, 1205-1211 (2004).
12. Ko, M. B. et al. Preparation of clay-dispersed polymer nanocomposite,U.S. Pat. No. 6,770,696, (2004)
13. Kuo, W.-F., Wu, J.-Y., Mao-Song, L. & Lee, S.-Y. Polymer nanocomposites and the process of preparing the same, U.S. Pat. No. 6,710,111, (2004)
14. Nigam, V., Setua, D. K., Mathur, G. N. & Kar, K. K. Epoxy-montmorillonite clay nanocomposites: Synthesis and characterization. Journal of Applied Polymer Science 93, 2201-2210 (2004).
15. Powell, C. E. Process for treating smectite clays to facilitate exfoliation, U.S. Pat. No. 6,730,719, (2004)
16. Rhoney, I., Brown, S., Hudson, N. E. & Pethrick, R. A. Influence of processing method on the exfoliation process for organically modified clay systems. I. Polyurethanes. Journal of Applied Polymer Science 91, 1335-1343 (2004).
17. Ross, M. & Kaizerman, J. Clay/organic chemical compositions useful as additives to polymer, plastic and resin matrices to produce nanocomposites and nonocomposites containing such compositions, U.S. Pat. No. 6,794,437, (2004)
18. Nettesheim, F., Grillo, I., Lindner, P. & Richtering, W. Shear-induced morphology transition and microphase separation in a lamellar phase doped with clay particles. Langmuir 20, 3947-3953 (2004).
19. Pollock, G. S., “Synthesis and Characterization of Mechanically Enhanced, Nanostructured Thermoplastic Polyurethane Elastomers,” PhD Thesis, Department of Chemical Engineering, MIT, June 2005.
20. James-Korley, L. T., “PEO-containing Copolymers as Polyurethane Soft Segments in the Development of High Performance Materials,” PhD Thesis, Department of Chemical Engineering, MIT, May 2005

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of dispersing particles in a medium, comprising:
providing a first particle/solvent dispersion comprising the particles and a first solvent;
adding a second solvent to the first particle/solvent dispersion to form a second particle/solvent dispersion, wherein the first solvent and the second solvent are miscible; and
extracting substantially all of the first solvent from the second particle/solvent dispersion to form a third particle/solvent dispersion.

2. The method of claim 1, wherein providing comprises dispersing the particles in the first solvent.

3. The method of claim 1, further comprising dissolving a polymer in the third particle/solvent dispersion.

4. The method of claim 3, wherein dissolving a polymer comprises dissolving the polymer in a solvent and combining the third particle/solvent dispersion and the polymer solution.

5. The method of claim 3, further comprising extracting at least a portion of the solvent from the third particle/solvent dispersion.

6. The method of claim 3, further comprising one or more of drying the third particle/solvent dispersion to remove at least a portion of the second solvent, film drying the third particle/solvent dispersion, spray-drying the third particle/solvent dispersion, wet spinning the third particle/solvent dispersion, electrospinning the third particle/solvent dispersion, and precipitating the polymer and particles from the third particle/solvent dispersion.

7. The method of claim 3, wherein the polymer is a block copolymer.

8. The method of claim 7, wherein the block co-polymer is a polyurethane.

9. The method of claim 8, wherein the polyurethane comprises polytetramethylene oxide.

10. The method of claim 7, wherein the block co-polymer is a polyester, polyethylene glycol-polypropylene glycol-polyethylene oxide polymer, acrylonitrile-butadiene-styrene polymer, or a polyurea.

11. The method of claim 3, wherein the polymer is selected from polyesters, polyamides, polyurethanes, polyureas, polyacrylates, polymethacrylates, polyolefins, polycarbonates, polyisoprenes, polybutylenes, and polyethylene terephthalate, poly methyl methacrylates, polyacrylonitrile, polyimides, carboxymethyl cellulose, polyethylene oxide, polyethers, polyethyl acrylates, glycerine polyesters, acrylonitrile/butadiene/styrene (ABS) rubbers, epoxy resins, polyesters, polyacrylamides, polyacrylic acids, quaternary amine modified cellulose, dextrans, gelatins, octadecylmethacrylate, polystyrene, polyvinylchloride, polyacetals, polyureas, and polyoxymethylene.

12. The method of claim 1, wherein extracting comprises distillation.

13. The method of claim 1, wherein the first solvent is selected from water, methanol, ethanol, n-propanol, 2-propanol, butanol, chloroform, dichloromethane, acetone, glycerol, ethylene glycol, or a mixture of any of the above.

14. The method of claim 1, wherein the second solvent is selected from xylene, tetrahydrofuran, dichlorobenzene, dimethylacetamide, dimethylformamide, dimethylsulfoxide, sulfolane, ethylene glycol, water, n-methyl pyrrolidinone, an alcohol having at least six carbons, or a mixture of any of the above.

15. The method of claim 1, wherein providing comprises increasing the ionic strength or modifying the pH of the first solvent.

16. The method of claim 1, further comprising including a salt in the first particle/solvent dispersion.

17. The method of claim 1, further comprising including a base in the first particle/solvent dispersion.

18. The method of claim 1, further comprising including a surfactant in the first particle/solvent dispersion.

19. The method of claim 1, further comprising including one or more of polyethylene glycol and polypropylene glycol in the first particle/solvent dispersion.

20. The method of claim 1, wherein the concentration of particles in the first particle/solvent dispersion is at least about 0.01 weight percent.

21. The method of claim 1, wherein the concentration of particles in the first particle/solvent dispersion is at least about 1 weight percent.

22. The method of claim 1, wherein the concentration of particles in the first particle/solvent dispersion is at least about 3 weight percent.

23. The method of claim 1, wherein the concentration of particles in the first particle solvent/dispersion is at least about 10 weight percent.

24. The method of claim 1, wherein the concentration of particles in the first particle solvent/dispersion is at least about 20 weight percent.

25. The method of claim 1, wherein the concentration of particles in the first particle solvent/dispersion is at least about 30 weight percent.

26. The method of claim 1, wherein the concentration of particles in the first particle solvent/dispersion is at least about 40 weight percent.

27. The method of claim 1, wherein the concentration of particles in the first particle solvent/dispersion is at least about 50 weight percent.

28. The method of claim 1, wherein the particles are about 1 nm to about 5 μm.

29. The method of claim 28, wherein the particles are about 1 nm to about 1 μm.

30. The method of claim 28, wherein the particles are about 1 μm to about 5 μm.

31. The method of claim 1, wherein the particles have at least one aspect ratio between about 1:1 and about 300:1.

32. The method of claim 1, wherein the particles have at least one aspect ratio between about 1:1 and about 10:1.

33. The method of claim 1, wherein the particles have at least one aspect ratio between about 10:1 and about 100:1.

34. The method of claim 1, wherein the particles have at least one aspect ratio between about 100:1 and about 300:1.

35. A particulate reinforced composite produced by the steps of:
providing a first particle/solvent dispersion comprising the particles and a first solvent;
adding a second solvent to the first particle/solvent dispersion to form a second particle/solvent dispersion, wherein the first solvent and the second solvent are miscible;
extracting substantially all of the first solvent from the second particle/solvent dispersion to form a third particle/solvent dispersion;
dissolving a polymer in the third particle/solvent dispersion to form a dispersed particle/dissolved polymer mixture; and
extracting at least a portion of the solvent from the mixture.

36. The method of claim 35, wherein dissolving a polymer comprises dissolving the polymer in a solvent and combining the third particle/solvent dispersion and the polymer solution.

37. The method of claim 35, wherein providing comprises dispersing the particles in the first solvent.

38. The method of claim 35, wherein extracting comprises one or more of drying the third particle/solvent dispersion to remove at least a portion of the second solvent, film drying the third particle/solvent dispersion, spray-drying the third particle/solvent dispersion, wet spinning the third particle/solvent dispersion, electrospinning the third particle/solvent dispersion, and precipitating the polymer and particles from the third particle/solvent dispersion.

39. The method of claim 35, wherein the polymer is a block copolymer.

40. The method of claim 39, wherein the block co-polymer is a polyurethane.

41. The method of claim 40, wherein the polyurethane comprises polytetramethylene oxide.

42. The method of claim 39, wherein the block co-polymer is a polyester, polyethylene glycol-polypropylene glycol-polyethylene oxide polymer, acrylonitrile-butadiene-styrene polymer, or a polyurea.

43. The method of claim 35, wherein the polymer is selected from polyesters, polyamides, polyurethanes, polyureas, polyacrylates, polymethacrylates, polyolefins, polycarbonates, polyisoprenes, polybutylenes, and polyethylene terephthalate, poly methyl methacrylates, polyacrylonitrile, polyimides, carboxymethyl cellulose, polyethylene oxide, polyethers, polyethyl acrylates, glycerine polyesters, acrylonitrile/butadiene/styrene (ABS) rubbers, epoxy resins, polyesters, polyacrylamides, polyacrylic acids, quaternary amine modified cellulose, dextrans, gelatins, octadecylmethacrylate, polystyrene, polyvinylchloride, polyacetals, polyureas, and polyoxymethylene.

44. The method of claim 35, wherein extracting comprises distillation.

45. The method of claim 35, wherein the first solvent is selected from water, methanol, ethanol, n-propanol, 2-propanol, butanol, chloroform, dichloromethane, acetone, glycerol, ethylene glycol, or a mixture of any of the above.

46. The method of claim 35, wherein the second solvent is selected from xylene, tetrahydrofuran, dichlorobenzene, dimethylacetamide, dimethylformamide, dimethylsulfoxide, sulfolane, ethylene glycol, water, n-methyl pyrrolidinone, an alcohol having at least six carbons, or a mixture of any of the above.

47. The method of claim 35, wherein providing comprises increasing the ionic strength or modifying the pH of the first solvent.

48. The method of claim 35, further comprising including a salt in the first particle/solvent dispersion.

49. The method of claim 35, further comprising including a base in the first particle/solvent dispersion.

50. The method of claim 35, further comprising including a surfactant in the first particle/solvent dispersion.

51. The method of claim 35, further comprising including one or more of polyethylene glycol and polypropylene glycol in the first particle/solvent dispersion.

52. The method of claim 35, wherein the concentration of particles in the first particle/solvent dispersion is at least about 0.01 weight percent.

53. The method of claim 35, wherein the concentration of particles in the first particle/solvent dispersion is at least about 1 weight percent.

54. The method of claim 35, wherein the concentration of particles in the first particle/solvent dispersion is at least about 3 weight percent.

55. The method of claim 35, wherein the concentration of particles in the first particle solvent/dispersion is at least about 10 weight percent.

56. The method of claim 35, wherein the concentration of particles in the first particle solvent/dispersion is at least about 20 weight percent.

57. The method of claim 35, wherein the concentration of particles in the first particle solvent/dispersion is at least about 30 weight percent.

58. The method of claim 35, wherein the concentration of particles in the first particle solvent/dispersion is at least about 40 weight percent.

59. The method of claim 35, wherein the concentration of particles in the first particle solvent/dispersion is at least about 50 weight percent.

60. The method of claim 35, wherein the particles are about 1 nm to about 5 μm.

61. The method of claim 60, wherein the particles are about 1 nm to about 1 μm.

62. The method of claim 60, wherein the particles are about 1 μm to about 5 μm.

63. The method of claim 35, wherein the particles have at least one aspect ratio between about 1:1 and about 300:1.

64. The method of claim 35, wherein the particles have at least one aspect ratio between about 1:1 and about 10:1.

65. The method of claim 35, wherein the particles have at least one aspect ratio between about 10:1 and about 100:1.

66. The method of claim 35, wherein the particles have at least one aspect ratio between about 100:1 and about 300:1.
